(19) United States
(12) Patent Application Publication
(10) Pub. No.: US 2011/0203557 A1
(43) Pub. Date: Aug. 25, 2011

(54) INTERNAL COMBUSTION ENGINE WITH A PRESSURE WAVE SUPERCHARGER, AND METHOD FOR OPERATING ANCILLARY UNITS OF AN INTERNAL COMBUSTION ENGINE

(75) Inventors: Georg Glitz, Paderborn (DE); Christian Smatloch, Paderborn (DE)

(73) Assignee: Benteler Automobiltechnik GmbH, Paderborn (DE)

(21) Appl. No.: 13/124,727

(22) PCT Filed: Oct. 10, 2009
(86) PCT No.: PCT/DE2009/001413

§ 371 Date: Apr. 18, 2011

(30) Foreign Application Priority Data
Oct. 20, 2008 (DE) 10 2008 052 113.2

(51) Int. Cl. F02B 33/42

(52) U.S. Cl. 123/559.2

(57) ABSTRACT

An internal combustion engine (1) includes a pressure wave supercharger (2), wherein the air quantity in a charge air flow produced by the pressure wave supercharger (2) is greater than the air quantity that can be absorbed on average by the internal combustion engine. The internal combustion engine is characterized in that the portion of the charge air flow (7) not absorbed by the internal combustion engine (1) is intended to be supplied to at least one ancillary unit (8, 9, 10, 11) of the internal combustion engine (1) or to at least indirectly cool parts of the internal combustion engine (1).

The invention relates to an internal combustion engine with a pressure wave supercharger according to the features in the preamble of patent claim 1 as well as to a method for operating ancillary units of an internal combustion engine according to the features of patent claim 6.

It is known to enable a reduction of the fuel consumption by using in particular pressure wave superchargers, when the internal combustion engine is charged. It is further known that pressure wave superchargers generate significantly more boost pressure as a result of their high capacity than an engine is capable on average to absorb combustion air. The excess air quantity must therefore be controlled with suitable measures. This is implemented, e.g. with the assistance of supercharger throttles and/or wastegates (EP 0 885 352 B1). Currently known pressure wave superchargers require however adjustment of the respectively required air quantity for the internal combustion engine for a particular operating point through control of the rotor speed, adjusting the supercharger throttle, wastegate and the housing offset angle. As a result, a significant proportion of energy contained in the exhaust flow is diverted unused into the exhaust tract.

The invention is based on the object to improve the overall efficiency of internal combustion engines which are provided with a pressure wave supercharger.

This object is solved by an internal combustion engine with the features of patent claim 1. A respective method is set forth in patent claim 6.

Advantageous refinements of the inventive idea are the subject matter of the subclaims.

The internal combustion engine according to the invention provides for the use of the portion of the charge air flow which is not absorbed by the internal combustion engine to be supplied to at least one ancillary unit of the internal combustion engine and to at least indirectly cool parts of the internal combustion engine. As a result, the pressure wave supercharger can be operated at its optimum operating point, whereby the greatest possible energy potential can be utilized by the exhaust gas driving the pressure wave supercharger, without the need to path-control excess charge air quantity. By utilizing the portion of the charge air flow that is not absorbed by the internal combustion engine, energy losses are significantly reduced especially because the charge air flow can be used for a multiplicity of ancillary units. The term ancillary unit is to be understood within the scope of the invention as relating in particular to turbo machines in the form of turbines. Such turbines can be provided for driving an electric generator or also a pump, in particular a compressor, air conditioning unit, or a power steering pump. The ancillary unit may also involve a power brake.

Furthermore, the portion of the charge air flow that is not absorbed by the internal combustion engine may be provided for cooling hot parts of an exhaust system of the internal combustion engine.

The advantage of the internal combustion engine according to the invention resides in an improved overall efficiency as a consequence of a lower fuel consumption because a greater part of energy contained in the exhaust gas is utilized.

Moreover, the invention has the added advantage of a slower operating change of the rotor speed as well as a slower control edge shift.

It is also a subject matter of the invention to provide a method with the features of patent claim 6, wherein the charge air flow produced by the pressure wave supercharger is greater than the charge air flow that can be absorbed on average by the internal combustion engine. The portion of the charge air flow that is not absorbed by the internal combustion engine is hereby supplied to at least one ancillary unit of the internal combustion engine or is used to at least indirectly cool the internal combustion engine.

The invention will now be described in greater detail with reference to an exemplary embodiment shown schematically in a drawing.

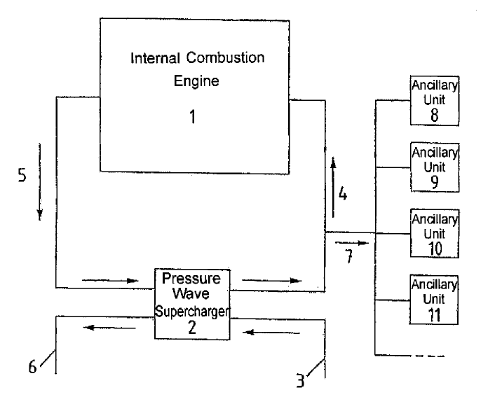

FIG. 1 shows an internal combustion engine 1 with an upstream pressure wave supercharger 2. The pressure wave supercharger 2 draws fresh air via a suction tube 3 and compresses the fresh air. The compressed charge air flow 4 is supplied to the internal combustion engine 1. Exhaust gas 5 from the internal combustion engine 1 is fed to the pressure wave supercharger 2 via an exhaust line, thereby driving the pressure wave supercharger 2. Exhaust gas 5 is then routed to an exhaust 6.

An essential feature of the internal combustion engine according to the invention involves the supply of a partial flow 7 of the charge air 4 to ancillary units 8, 9, 10, 11. The ancillary units may involve, e.g., an electric generator 8, for example in order to charge an electric battery of the motor vehicle. The ancillary unit 9 may involve a compressor of an air conditioning system. The ancillary unit 10 may involve a power steering pump which is operated by the portion 7 of the charge air flow. The ancillary unit 11 may involve a power brake. Further ancillary units which are not shown in greater detail can be operated via the charge air flow. The invention is not limited to a particular configuration of an ancillary unit. An ancillary unit within the scope of the invention relates to any component of a motor vehicle that can be supplied indirectly with energy via the internal combustion engine and is capable of being driven by means of charge air.

The greatly simplified illustration of the inventive idea does not preclude the provision of control and regulating means which are noₜ shown in greater detail and provided to supply the partial flow 7 that is not absorbed by the internal combustion engine in measured quantities to one or more ancillary units 8-11. Of course, it is within the scope of the invention to change the absorbed charge air quantity of the internal combustion engine 1 through provision of control and regulating elements (charge air flap, wastegate) not shown in greater detail.

### REFERENCE SIGNS

1—internal combustion engine

2—pressure wave supercharger

3—suction tube

4—absorbed portion of the charge air flow

5—exhaust gas

6—exhaust

7—non-absorbed portion of the charge air flow

8—ancillary unit

9—ancillary unit

10—ancillary unit

11—ancillary unit

1.-11. (canceled)

12. An internal combustion engine, comprising a pressure wave supercharger producing a charge air flow with an air quantity which is greater than an air quantity that can be absorbed on average by the internal combustion engine, wherein the charge air flow has a portion which is not absorbed by the internal combustion engine for supply to at least one ancillary unit of the internal combustion engine or to at least indirectly cool parts of the internal combustion engine.

13. The internal combustion engine of claim 12, wherein the ancillary unit is a turbine for driving an electric generator, a pump, in particular a compressor of an air conditioning unit, or a power steering pump.

14. The internal combustion engine of claim 12, wherein the ancillary unit is a power brake.

15. The internal combustion engine of claim 12, wherein the non-absorbed portion of the charge air flow is provided for cooling hot parts of an exhaust system of the internal combustion engine.

16. The internal combustion engine of claim 12, further comprising a charge air flap for controlling the portion of the charge air flow not absorbed by the internal combustion engine.

17. A method of operating an ancillary unit of an internal combustion engine in combination with a pressure wave supercharger, wherein a charge air flow produced by the pressure wave supercharger is greater than is absorbed on average by the internal combustion engine, said method comprising the step of supplying a portion of the charge air flow that is not absorbed by the internal combustion engine to the ancillary unit of the internal combustion engine or to at least indirectly cool a part of the internal combustion engine.

18. The method of claim 17, wherein the ancillary unit is a turbine for driving an electric generator, a pump, in particular a compressor of an air conditioning unit, or a power steering pump, wherein the turbine is driven by the portion of the charge air flow not absorbed by the internal combustion engine.

19. The method of claim 17, wherein the ancillary unit is a power brake.

20. The method of claim 17, wherein the non-absorbed portion of the charge air flow is used to cool hot parts of an exhaust system of the internal combustion engine.

21. The method of claim 17, further comprising the step of controlling the portion of the charge air flow not absorbed by the internal combustion engine by a charge air flap.

22. The method of claim 17, wherein the non-absorbed portion of the charge air flow is used to cool electric and electronic components in an engine compartment.
